(19) United States
(12) Patent Application Publication
(10) Pub. No.: US 2007/0097009 A1
(43) Pub. Date: May 3, 2007

(54) PLANAR SLOT ANTENNA DESIGN USING OPTICALLY TRANSMISSIVE MATERIALS

(76) Inventor: Alfonso R Torres, Dayton, OH (US)

Correspondence Address: Intellectual Property Group;Bose McKinney & Evans LLP, Suite 2700, 135 North Pennsylvania Street, Indanapolis, IN, 46204, US

(21) Appl. No.: 11/554,684

(22) Filed: Oct. 31, 2006

Related U.S. Application Data
(60) Provisional application No. 60/732,429, filed on Nov. 1, 2005.

(51) Int. Cl. H01Q 9/28

(52) U.S. Cl. 343/795

(57) ABSTRACT

An optically transmissive antenna including an optically transmissive aperture for a slot-type configuration antenna fabricated on a high transmission substrate; coplanar waveguide feedlines formed on the substrate, the coplanar waveguide feedlines defining a center portion and an exterior portion; a first connection point for connecting the center portion to a first conductor; and a second connection point for connecting the exterior portion to a second conductor. The substrate can be rigid or flexible. Also a method of making the antenna including the steps of selecting a high transmission substrate; sputtering the substrate with a highly transparent conductive layer; removing the highly transparent conductive layer from the substrate to form an aperture and a pair of coplanar waveguide feedlines for the antenna. The antenna can be connected using micro-coaxial cable.

### TECHNICAL FIELD OF THE INVENTION

The present invention relates to an antenna design using optically invisible materials. More specifically, the present invention relates to an optically transparent aperture antenna design with coplanar waveguide feed (CPW). The invention provides transparent antennas which do not require the use of vias and are properly “matched” with CPW structures.

### BACKGROUND AND SUMMARY OF THE INVENTION:

The concept for designing optically transmissive (synonymous with transparent or visibly clear) antennas has been investigated by multiple organizations and individuals. The coupling of these apertures with simplistic feedlines has not been widely investigated. Very little work has been done in the development of optically transmissive apertures with low resistivity surfaces (<15 Ω/square) and without the use of vias.

The present invention discloses such approaches as coplanar waveguide feeds (CPW) and the connection of those CPW feeds to miniature 50 ohm coaxial cables. The use of CPW provides an innovative approach to the design and fabrication of feedlines to optically transmissive apertures, regardless of type, provided they are “slot” type configurations. Without the use of CPW feedlines, the optically transmissive apertures visibility is severely compromised.

Two examples of antennas designed and developed using planar slot apertures fabricated with high transmission optically clear materials are presented herein. The antennas were fabricated both on Mylar and Glass substrates using both High Transmission Silver and Indium Tin Oxide (ITO). The apertures were slot type antennas. One antenna was configured as a slot bow tie antenna with tuning stubs and the other antenna was configured as a slot dipole. Both antennas were fed with a coplanar waveguide feeds in order to eliminate the use of vias when such electromagnetic waves were launched with micro-type coax cable (50 ohm based). The micro-coax used was basically a 32 mils outside diameter which made the total installation very low profile. Measurements indicate that it is possible to fabricate optically transmissive apertures with similar performance levels as apertures implemented using copper conductive materials. It was also discovered that coupling to these planar structures with coaxial cables became problematic for the flexible apertures; for solid materials (for example, glass), conductive bonds implementations were trouble free.

### BRIEF DESCRIPTION OF THE DRAWINGS

FIG. 1 shows a schematic of a bow-tie antenna with tuning stubs embodiment;

FIG. 2 shows a schematic of a slot dipole antenna embodiment;

FIG. 3 shows a schematic of a coplanar waveguide portion of an antenna embodiment and its connection to a coaxial cable;

FIG. 4 shows a graph of return loss versus frequency for a Mylar bow-tie antenna using silver epoxy material to bond the coaxial cable feedlines directly to the coplanar waveguide feeds;

FIG. 5 shows a graph of return loss versus frequency for a Mylar bow-tie antenna using copper tape to bond the coaxial cable feedlines directly to the coplanar waveguide feeds;

FIG. 6 shows a graph of return loss versus frequency for a Mylar bow-tie antenna using copper tape soldered to the coaxial cable feedlines and bonding the copper tape to the coplanar waveguide feeds;

FIG. 7 shows a graph of return loss versus frequency for a glass substrate slot dipole antenna using silver epoxy material to bond the coaxial cable feedlines directly to the coplanar waveguide feeds; and

FIG. 8 shows a glass substrate slot dipole antenna using silver epoxy material to bond coaxial cable feedlines directly to the coplanar waveguide feeds.

### DETAILED DISCLOSURE OF THE INVENTION

In the following description, two exemplary antenna embodiments are described. It will be obvious to those skilled in the art that the invention applies to many other possible embodiments as well. One embodiment described is a bow-tie antenna with tuning stubs and the other is a simple dipole antenna. Both antennas are implemented in the “slot” configuration. The main reason for deciding to use slot type configurations is based on the implementation and fabrication process. It is usually easier to “remove” material from a sputtered sheet of conductive surface over glass or Mylar than to deposit material of a certain geometrical configuration. The removal of the material was done with the use of laser ablation processes. An alternative removal technique involves the use of chemical baths. The process of laser ablation produces a resolution aperture without disturbing other parts of the sputtered conductive material. The results were very good using this fabrication process.

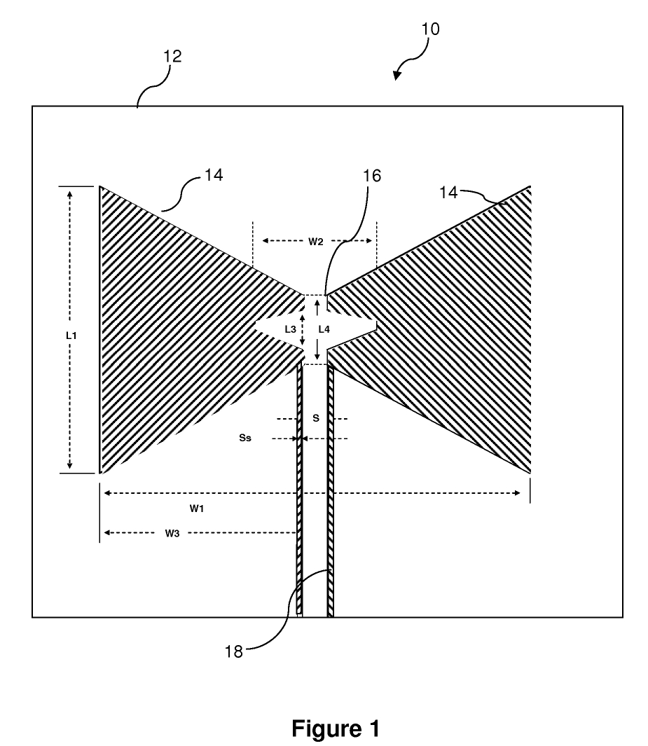

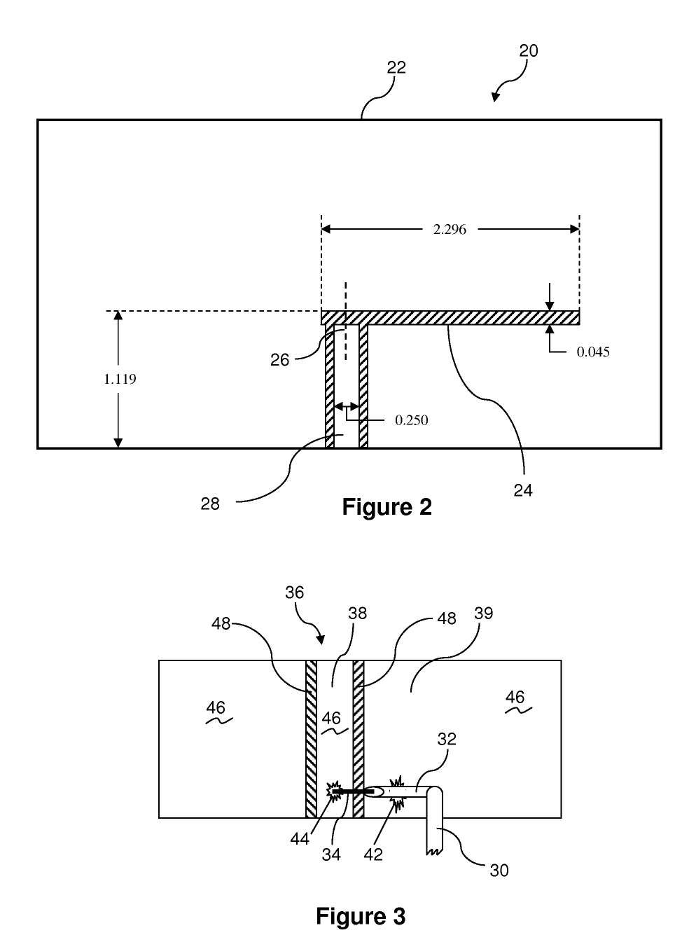

FIG. 1 shows an embodiment of the bow-tie antenna configuration 10. FIG. 2 shows an embodiment of the slot dipole antenna 20. Both embodiments 10, 20 include a CPW feedline 18, 28, respectively. Both antennas 10, 20 were designed for an operating center frequency of 2.0 GHz.

For the bow-tie antenna embodiment 10 shown in FIG. 1, a Mylar (polyester) substrate 12 was used. The substrate 12 was sputtered with a highly-transparent, highly conductive layer of High Transmission Silver (AgHT™) which was obtained from CP Films Inc. of Martinsville, Va. The AgHT surface has a resistivity of 8 ohms/square. The antenna configuration 10 is fed with CPW type feedline 18, such configuration being done in a planar manner using the same sputtered conductive surface. The CPW feedline 18 was made to 50 ohms impedance, allowing easier interface to the micro-coaxial cable used. The design of the CPW feedline 18 is not described in detail since the design is straight forward and easily implementable by one skilled in the art with web downloadable software, one source of such information is www.rfcafe.com.

The fabrication of the aperture was made with the use of laser ablation. The drawing of the design of the bow-tie antenna 10 was made using AutoCad and such design was then provided to Laserod of Gardena, Calif., to provide laser ablation functions on multiple material surfaces. The laser ablation removed the AgHT material from the bow-tie portions 14 and the sides of the CPW feedline 18, as shown by the cross-hatched portions of FIG. 1. Preparations were then made to connect the coaxial cables to the CPW feeds 18.

For the slot dipole antenna embodiment 20 shown in FIG. 2, a glass substrate 22 was used. The glass substrate 22 was sputtered with a highly-transparent, quasi-metallic material of Indium Tin Oxide (ITO) which was obtained from Chomerics of Woburn, Mass., (CHO-ITO™). The ITO surface has a resistivity of 12 ohms/square. Modifications to transmission line program from Zeland Software, Inc. of Fremont, Calif., were made to account for the lower conductivity of the ITO material. The slot aperture 20 is fed with CPW type feedline 28, such configuration being done in a planar manner using the same sputtered conductive surface. The CPW feedline 28 can be impedance matched with the slot aperture 20 at a feed point 26 and also impedance matched at a connection point for a cable. For example, the CPW feedline 28 was made to 50 ohms impedance at the connection point, allowing easier interface to the micro-coaxial cable used. The feed point 26 in this embodiment is located λ/20 from the slot dipole edge.

The fabrication of the aperture was made with the use of laser ablation. The drawing of the design of the slot dipole antenna 20 was made using AutoCad and such design was then provided to Laserod of Gardena, Calif., to provide laser ablation functions on multiple material surfaces. The laser ablation removed the ITO material from the slot aperture portion 24 and the sides of the CPW feedline 28, as shown by the cross-hatched portions of FIG. 2. Preparations were then made to connect the coaxial cables to the CPW feedline 28 of the slot dipole antenna 20.

Initially, the “bonding” of the center conductor and the shield of the coaxial cable to the planar sputtered surfaces and the CPW feedlines of the antennas shown in FIGS. 1 and 2 was done using a silver epoxy material. FIG. 3 illustrates the bonding of the conductors of a coaxial cable 30 to a CPW feedline 36. FIG. 3 shows a substrate covered with a sputtered conductive material 46 except for two sides 48 of the CPW feedline 36. The sides 48 of the CPW feedline 36 define a center portion 38 of the CPW feedline 36 and an exterior portion 39. The coaxial cable 30 comprises a shield 32 and a center conductor 34. The shield 32 of the coaxial cable 30 is connected with silver epoxy material to the sputtered conductive material 46 at a location 42 in the exterior portion 39, and the center conductor 34 of the coaxial cable 30 is connected to the center portion 38 of the CPW feedline 36 at a location 44.

Measurements using the network analyzer were made to obtain S₁₁ parameters (return loss e.g. VSWR). The bonding to the sputtered material on the Mylar substrate produced poor results but the bonding to the sputtered material on the glass substrate produced excellent results. It was determined that because of the flexibility of the Mylar substrate, the bonding of the coaxial cable was “broken” thus producing very poor results. Alternative configurations, to be described below, were investigated for bonding the coaxial cable to the Mylar substrate.

One alternative, is to use conductive adhesive copper tape to bond the shield 32 of the coaxial cable 30 to the sputtered conductive material, and to bond the center conductor 34 of the coaxial cable 30 to the center portion 38 of the CPW feedline 36.

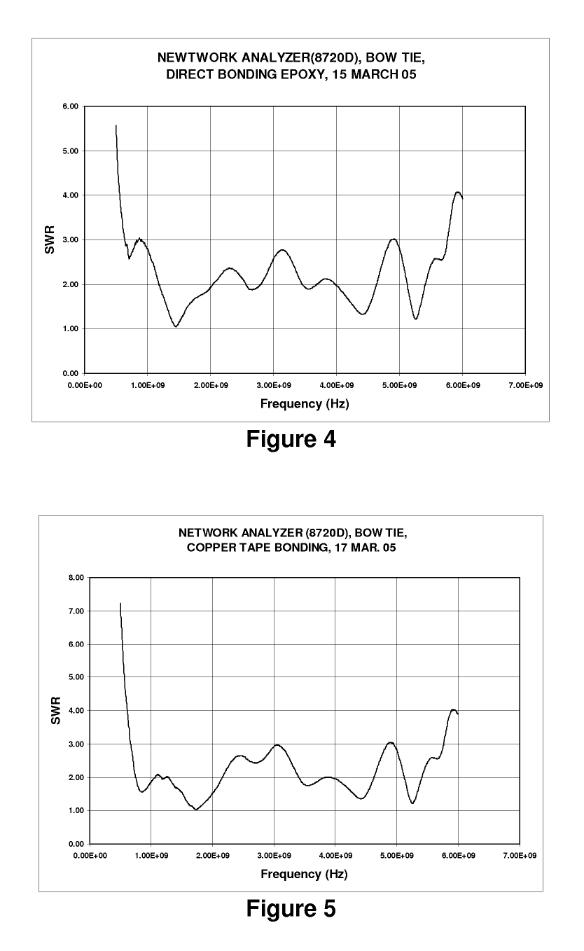

FIG. 4 shows the voltage standing wave ratio (VSWR or SWR) when using the silver epoxy material to bond the coaxial conductors to the aperture on a Mylar surface and FIG. 5 shows the SWR when using the copper tape to bond the coaxial conductors to the aperture on a Mylar surface. The apertures were identical and by bonding the coaxial feedline with the use of copper tape, an improvement was achieved in the VSWR. As can be observed by comparing FIG. 5 with FIG. 4, the return loss function indicates better performance with the copper tape than with the silver epoxy material. However, other alternatives were also investigated.

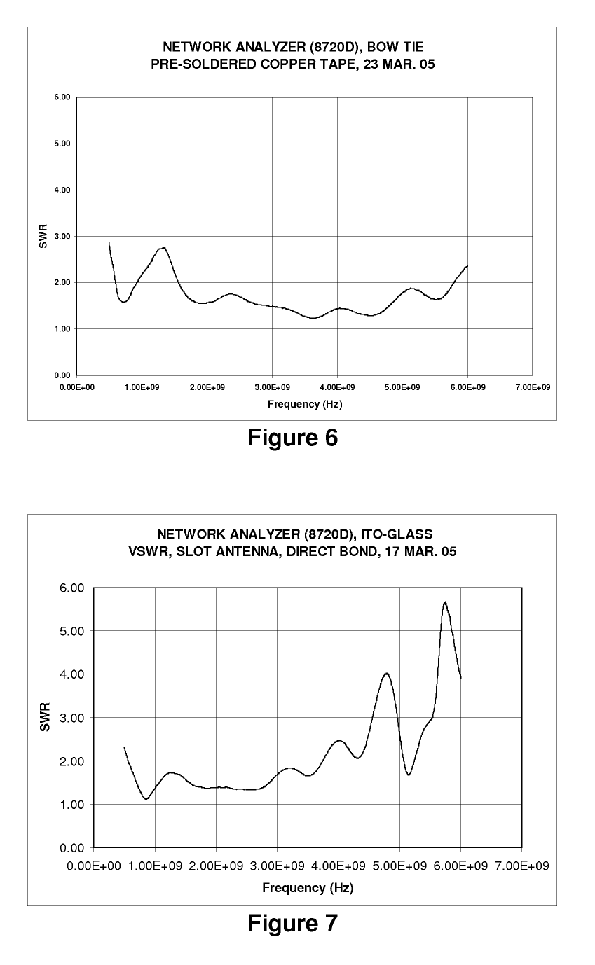

The concept was advanced further by soldering the conductors of the coaxial cable to the copper tape and then bonding the copper tape to the CPW structure of the antenna. This implementation improved the results further. FIG. 6 shows the return loss function for this implementation. The plot in FIG. 6 shows good impedance matching from 1.5 GHz to about 5.8 GHz with a VSWR of less than 2. If we allow a VSWR of less than 3, then the aperture coverage is from 0.5 GHz to about 6 GHz.

As can be seen from the differences in the plots of FIGS. 4, 5 and 6, the mating of the conductors of the coaxial cable to the flexible antenna surface greatly impacts the results of the antenna. In the case of the rigid substrate like glass, the direct bonding method using silver conductive adhesive proved to be very good.

FIG. 7 shows the VSWR performance of the slot dipole antenna on glass. A VSWR of less than 2 was obtained between 0.7 GHz and 3.5 GHz. Above about 4 GHz, the slot dipole becomes non-resonant and the VSWR begins to rise accordingly. Similar results were obtained in the Mylar configuration (flexible aperture) when connections to the CPW feedline were made using the copper tape approach and the soldered coaxial cable and copper tape approach.

Optical transmission of the Mylar Silver aperture was 85% and the optical transmission of the Glass ITO aperture was 89%. The aperture of the bow-tie antenna is more visible than the aperture of the slot dipole antenna because the removed area for the bow-tie antenna is much greater as can be seen in FIG. 1.

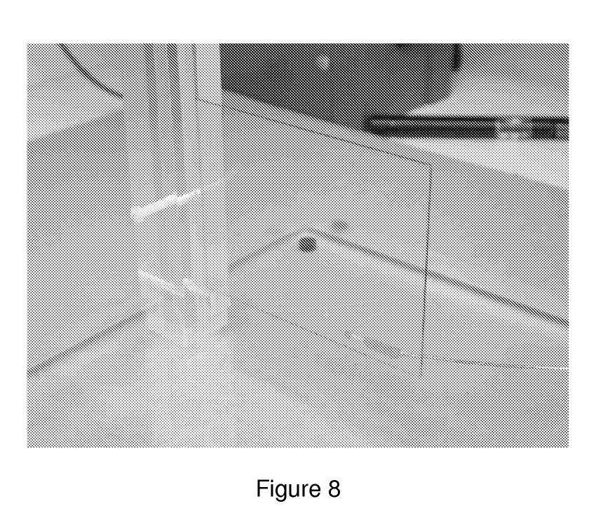

FIG. 8 shows the slot dipole antenna with a glass substrate. The glass substrate was 47 mils thick of standard window glass (Borosilicate or Soda-Lime glass). As shown in the figure, the small coaxial cable is directly bonded to the ITO CPW feed. Results of this configuration are shown in FIG. 7. This configuration was well behaved electromagnetically using the silver epoxy bond.

While the invention has been illustrated and described in detail in the drawings and foregoing description, such illustration and description are exemplary and not restrictive in character, it being understood that only exemplary embodiments have been shown and described and that all changes and modifications that come within the spirit of the invention and the attached claims are desired to be protected.

I claim:

1. An optically transmissive antenna comprising:
an optically transmissive aperture for a slot-type configuration antenna fabricated on an optically high transmission substrate, the aperture having a feed point;
optically transmissive coplanar waveguide feedline fabricated on the substrate and connected to the aperture at the feed point, the coplanar waveguide feedline having two sides, the two sides defining a center portion of the coplanar waveguide feedline and an exterior portion;
a first connection point for connecting the center portion to a first conductor; and
a second connection point for connecting the exterior portion to a second conductor.

2. The antenna of claim 1, wherein the coplanar waveguide is impedance matched to the aperture at the feed point and the coplanar waveguide is impedance matched to the first conductor at the first connection point.

3. The antenna of claim 1, wherein the substrate is flexible.

4. The antenna of claim 3, wherein the substrate is a substantially clear polyester and the antenna is fabricated using high transmission silver.

5. The antenna of claim 1, wherein the substrate is glass and the antenna is fabricated using indium tin oxide (ITO).

6. The antenna of claim 1, wherein the antenna is configured as a slot bow-tie antenna with tuning stubs.

7. The antenna of claim 1, wherein the antenna is configured as a slot dipole antenna.

8. The antenna of claim 1, wherein the first and second connection points are designed to be connected to a coaxial cable having a center conductor and a shield, the first connection point being designed to be connected to the center conductor of the coaxial cable and the second connection point being designed to be connected to the shield of the coaxial cable.

9. The antenna of claim 1, wherein the antenna has an optical transmission greater than 80%.

10. A method of making an optically transmissive antenna in a slot-type configuration, the method comprising:
selecting a high transmission substrate;
sputtering the substrate with a highly optically transparent conductive layer;
removing the highly transparent conductive layer from the substrate to form an aperture and a pair of sides of a coplanar waveguide feedline, the pair of sides defining a center portion of the coplanar waveguide feedline and an exterior portion, the coplanar waveguide feedline connecting to the aperature at a feed point.

11. The method of claim 10, wherein the removing step is done using laser ablation.

12. The method of claim 10, further comprising:
connecting a first conductor to the center portion of the coplanar waveguide feedline at a first connection point; and
connecting a second conductor to the exterior portion defined by the pair of sides at a second connection point.

13. A method of claim 12, further comprising:
impedance matching the coplanar waveguide feedline to the aperture at the feed point, and
impedance matching the coplanar waveguide feedline to the first conductor at the first connection point.

14. The method of claim 10, further comprising:
connecting a coaxial cable having a center conductor and a shield to the antenna; the connecting a coaxial cable step comprising
connecting the center conductor to the center portion of the coplanar waveguide feedline; and
connecting the shield to the exterior portion.

15. The method of claim 10 further comprising:
connecting a first conductor to a first piece of conductive adhesive tape;
connecting a second conductor to a second piece of conductive adhesive tape;
bonding the first piece of conductive adhesive tape to the center portion of the coplanar waveguide feedline; and
bonding the second piece of conductive adhesive tape to the exterior portion.

16. The method of claim 15, wherein the conductive adhesive tape is metallic and the connecting steps are performed by soldering the conductors to the metallic tape.

17. An optically transmissive antenna comprising:
an optically transmissive aperture for a slot-type configuration antenna fabricated on a high transmission substrate;
an optically transmissive coplanar waveguide feedline fabricated on the substrate and connected to the aperture at the feed point, the coplanar waveguide feedline having two sides, the two sides defining a center portion of the coplanar waveguide feedline and an exterior portion; and
a coaxial cable having a center conductor and a shield, the center conductor of the coaxial cable being connected to the center portion of the coplanar waveguide feedline at a first connection point, and the shield of the coaxial cable being connected to the exterior portion at a second connection point;
wherein the coplanar waveguide feedline is impedance matched to the aperture at the feed point, and the coplanar waveguide feedline is impedance matched to the coaxial cable at the connection points.

18. The antenna of claim 17, wherein conductive adhesive tape is used in connecting the center conductor of the coaxial cable to the center portion, and in connecting the shield of the coaxial cable to the exterior portion.

19. The antenna of claim 17, wherein the center conductor of the coaxial cable is soldered to a first piece of conductive metallic adhesive tape and the first piece of tape is used to connect the center conductor to the center portion, and the shield of the coaxial cable is soldered to a second piece of conductive metallic adhesive tape and the second piece of tape is used to connect the shield to the exterior portion.

20. The antenna of claim 17, wherein the antenna has an optical transmission greater than 80%.
